(19) United States
(12) Patent Application Publication
(10) Pub. No.: US 2001/0028604 A1
(43) Pub. Date: Oct. 11, 2001

(54) Timepiece with calendar

(76) Inventors: Mamoru Watanabe, Chiba-shi (JP); Shigeo Suzuki, Chiba-shi (JP); Kenichi Nakajima, Chiba-shi (JP)

Correspondence Address: ADAMS & WILKS, 31st Floor, 50 Broadway, New York, NY, 10004, US

(21) Appl. No.: 09/814,519

(22) Filed: Mar. 22, 2001

(30) Foreign Application Priority Data
Mar. 31, 2000 (JP) 2000-096222

(51) Int. Cl. G04B 19/20; G04B 19/24

(52) U.S. Cl. 368/28; 368/37

(57) ABSTRACT

A timepiece with calendar mechanism has a main plate, a date indicator, a day indicator and a date indicator driving wheel. A date feed finger is structured integral with the date indicator driving wheel through a date feed finger spring portion, and a day feed finger is structured integral with the date indicator driving wheel through a day feed finger spring portion. The date feed finger rotates through a main-plate side of a day star wheel. The timepiece with calendar mechanism has a date feed finger guide portion to secure mesh in a thickness direction of the date feed finger and date indicator teeth portion when they mesh each other.

### BACKGROUND OF THE INVENTION

1. Field of the Invention:

The present invention relates to a timepiece with calendar mechanism and, more particularly, to a timepiece with small, thin calendar mechanism that is free from fear of erroneous operation of the day indicator.

2. Description of the prior Art:

Referring to FIG. 19 and FIG. 20, the conventional timepiece with calendar mechanism, e.g. a movement (mechanical body) 400 of an analog electronic timepiece, has a main plate 402 structuring a base plate of the movement 400. A dial 404 (shown by the virtual line in FIG. 20) is attached on the movement 400.

In the analog electronic timepiece, of the opposite sides of the main plate 402, the side the dial 404 exists is referred to as a “back side” of the movement 400 and the side opposite to the side having the dial 404 is referred to as a “front side” of the movement 400. The train wheel assembled on the “front side” of the movement 400 is referred to as a “front train wheel” and the train wheel assembled on the “back side” of the movement 400 is referred to as a “back train wheel”.

On the “front side” of the movement 400 are arranged a battery, a circuit block, a step motor, a front train wheel, a switch device (all not shown). By the rotation of the step motor, the front train wheel is rotated.

A center pipe 402a is provided on the main plate 402. An hour wheel 410 is provided rotatable relative to the center pipe 402a, and rotates twice per day due to rotation of the front train wheel. A date indicator driving wheel 412 is provided to rotate once per day due to rotation of the hour wheel 410.

A date indicator 420 is provided rotatable relative to the main plate in order to indicate date. The date indicator 420 has a date-indicator teeth portion 422 having 31 teeth and a date plate 424 printed with characters to indicate date. A day indicator 430 is provided rotatable relative to the main plate to indicate day of the week. The day indicator 430 has a day star wheel 432 having 7 or 14 or 21 teeth and a day plate 434 printed with characters to indicate day of the week.

The date indicator driving wheel 412 is provided with a date feed finger 414 capable of rotating the date indicator 420 by one day per day and a day feed finger 416 capable of rotating the day indicator 430 by one day per day.

The date feed finger 414 is structured integral with the date indicator driving wheel 412 through a date feed finger spring portion 414b. The day feed finger 416 is structured integral with the date indicator driving wheel 412 through a day feed finger spring portion 416b.

The date feed finger 414 is structured to rotate not to enter a rotation path of the day star wheel 432.

However, in the conventional timepiece with calendar mechanism, unless the date feed finger is arranged not to enter a rotation path of the day star wheel, the date feed finger will mesh with the day star wheel resulting in a fear of erroneously operation of the day indicator.

Furthermore, in order to reduce the planar size of the timepiece with calendar mechanism while avoiding erroneous operation of the day indicator, there is a need to secure sufficiently great a gap in a thickness direction between the date feed finger and the day star wheel, which tends to increase the thickness of the timepiece.

### SUMMARY OF THE INVENTION

Therefore, it is an object of the present invention to realize a small-and-thin type timepiece with calendar mechanism that is free from fear of erroneous operation of the day indicator, in order to solve the conventional problem as this.

Also, another object of the invention is to realize a timepiece with calendar mechanism provided with such a date feed mechanism that the date feed finger can positively rotate the date indicator.

In order to solve the above problem, the present invention is, in a timepiece with calendar having a main plate structuring a base plate of a movement, a date indicator rotatably provided relative to the main plate to indicate date and having a date indicator teeth portion, a day indicator rotatably provided relative to the main plate to indicate day of the week and having a day star wheel, and a date indicator driving wheel rotating once per day to enable the date indicator to rotate by an amount of one day per day and the day indicator to rotate by an amount of one day per day, characterized in that: the date indicator driving wheel having a date feed finger capable of rotating the date indicator by an amount of one day per day and a day feed finger capable of rotating the day indicator by an amount of one day per day; the date feed finger being structured integral with the date indicator driving wheel through a date feed finger spring portion; the day feed finger being structured integral with the date indicator driving wheel through a day feed finger spring portion; the date feed finger being structured to rotate passing on main plate side of the day star wheel of the day indicator; wherein provided is a date feed finger guide portion to secure meshing in a thickness direction between the date feed finger and the date indicator teeth portion when the date feed finger meshes with the date indicator teeth portion.

Also, in the timepiece with calendar mechanism, the date feed finger guide portion is preferably provided on a back side of the main plate.

Also, in the timepiece with calendar mechanism, a slant surface is preferably provided in a portion that the date indicator driving wheel rotates and the date feed finger first contacts the date feed finger guide portion.

Also, in the timepiece with calendar mechanism, a semispherical convex portion is preferably provided in a portion that the date feed finger contacts the date feed finger guide portion.

Also, in the timepiece with calendar mechanism, the day feed finger is preferably structured to pass through on a dial side of the date indicator teeth portion, and the day feed finger being structured to rotate contacting the date feed finger guide portion in order to secure a gap in a thickness direction between the day feed finger and the date indicator teeth portion when the day feed finger rotates through the dial side of the date indicator teeth portion.

By thus structuring, in the timepiece with calendar mechanism, there is no fear of erroneous operation of the day indicator so that the date feed finger can positively rotate the date indicator. Further, by thus structuring, it is possible to realize a small, thin timepiece with calendar mechanism.

Also, in the timepiece with calendar mechanism, preferably provided in place of providing the date feed guide portion are a date feed finger guide groove portion to secure a mesh amount in a thickness direction between the date feed finger and a feed operating tooth portion when the date feed finger meshes with the feed operating tooth portion to be fed, an inner guide portion to prevent a decrease of the mesh amount between the date feed finger and the feed operating tooth portion and an outer guide portion to prevent an increase of the mesh amount between the date feed finger and the feed operating tooth portion.

By providing an inner guide portion, it is possible to effectively prevent a mesh amount between the date feed finger and the operating tooth portion from decreasing more than required. Also, by providing an outer guide portion, it is possible to effectively prevent a mesh amount between the date feed finger and the operating tooth portion from increasing more than required. Accordingly, by thus structuring, the date feed finger can positively rotate the date indicator.

Also, in the timepiece with calendar mechanism, preferably provided is a date feed forward gap secure portion to secure a gap in a planar direction between the date feed finger and a feed waiting tooth portion when the date feed finger rotates through a point near the feed waiting tooth portion to be next fed.

By thus structuring, it is possible to eliminate the fear that prior to date the date feed finger erroneously operates the date indicator.

Furthermore, in the timepiece with calendar mechanism, preferably provided is a date feed rear gap secure portion to secure a gap in a planar direction between the date feed finger and a feed end tooth portion when the date feed finger rotates through a point near the feed end tooth portion having been fed.

By thus structuring, it is possible to eliminate the fear that after date the date feed finger erroneously operates the date indicator.

Also, in the invention, preferably the timepiece with calendar mechanism is structured as an analog electronic timepiece, the timepiece with calendar mechanism having a quartz oscillator structuring source oscillation and a step motor to rotate the front train wheel, the step motor being structured to include a coil block, a stator and a rotor, and one part of the quartz oscillator and one part of the coil block being arranged to overlap with the date indicator.

By thus structuring, in the timepiece with calendar mechanism, because one part of the quartz oscillator, one part of the coil block and date indicator can be arranged compactly, a small, thin timepiece with calendar mechanism can be realized.

### BRIEF DESCRIPTION OF THE DRAWINGS

A preferred form of the present invention is illustrated in the accompanying drawings in which:

FIG. 1. is a fragmentary sectional view showing an embodiment of a timepiece with calendar mechanism of the present invention;

FIG. 2. is a schematic plan view as viewed from a side having a calendar mechanism in the embodiment of the timepiece with calendar mechanism of the invention (showing a state that a date indicator holder and day plate is removed);

FIG. 3 is a schematic plan view as viewed from a side having a front train wheel (side opposite to the side the calendar mechanism exists) in the embodiment of the timepiece with calendar mechanism of the invention (showing a state that a train wheel bridge, insulation plate and holder plate is removed);

FIG. 4. is a fragmentary sectional view showing a quartz unit, date indicator driving wheel and coil block in the embodiment of the timepiece with calendar mechanism of the invention;

FIG. 5. is a magnified fragmentary plan view showing a date indicator, date indicator driving wheel and day star wheel in a date feed state in the embodiment of the timepiece with calendar mechanism of the invention;

FIG. 6. is a magnified fragmentary sectional view showing the date feed state of FIG. 5 in the embodiment of the timepiece with calendar mechanism of the invention;

FIG. 7. is a magnified fragmentary plan view showing the date indicator, date indicator driving wheel and day star wheel in a day feed state in the embodiment of the timepiece with calendar mechanism of the invention;

FIG. 8. is a magnified fragmentary sectional view showing the day feed state of FIG. 7 in the embodiment of the timepiece with calendar mechanism of the invention;

FIG. 9. is a magnified fragmentary plan view showing a state a date feed finger positions beneath the day star wheel in the embodiment of the timepiece with calendar mechanism of the invention;

FIG. 10. is a magnified fragmentary sectional view showing the state of FIG. 9 in the embodiment of the timepiece with calendar mechanism of the invention;

FIG. 11. is a magnified fragmentary plan view showing a state in which a day feed finger rides on a main plate base in the embodiment of the timepiece with calendar mechanism of the invention;

FIG. 12. is a magnified fragmentary sectional view showing the state of FIG. 11 in the embodiment of the timepiece with calendar mechanism of the invention;

FIG. 13. is a magnified fragmentary plan view showing a part of the main plate positioned under the date indicator driving wheel and day star wheel in the embodiment of the timepiece with calendar mechanism of the invention;

FIG. 14. is a magnified fragmentary plan view in the line A-A of FIG. 13 in the embodiment of the timepiece with calendar mechanism of the invention;

FIG. 15. is a magnified fragmentary plan view showing a state in which the date feed finger positions near a tooth tip of the date indicator having been fed in the embodiment of the timepiece with calendar mechanism of the invention;

FIG. 16. is a magnified fragmentary sectional view showing the state of FIG. 15 in the embodiment of the timepiece with calendar mechanism of the invention;

FIG. 17. is a fragmentary sectional view showing a case in which the day feed finger does not ride on the main plate base in the embodiment of the timepiece with calendar mechanism of the invention;

FIG. 18. is a fragmentary sectional view showing the case in which the day feed finger does not ride on the main plate base in the embodiment of the timepiece with calendar mechanism of the invention;

FIG. 19. is a magnified fragmentary plan view showing a date indicator, date indicator driving wheel and day star wheel in the conventional timepiece with calendar mechanism; and

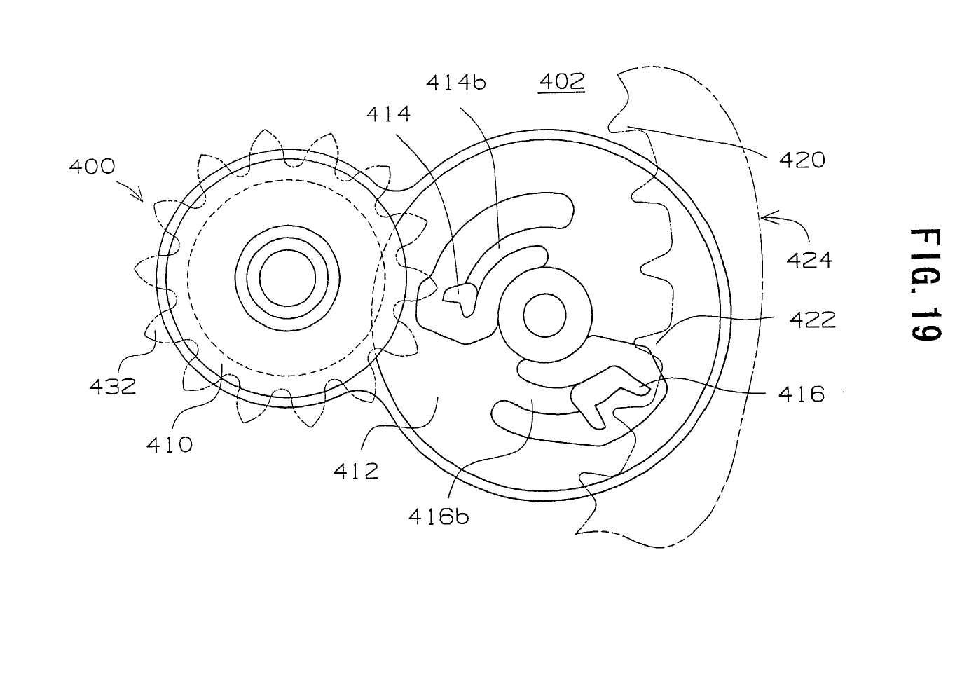

FIG. 20. is a magnified fragmentary sectional view of the part shown in FIG. 19 in the conventional timepiece with calendar mechanism.

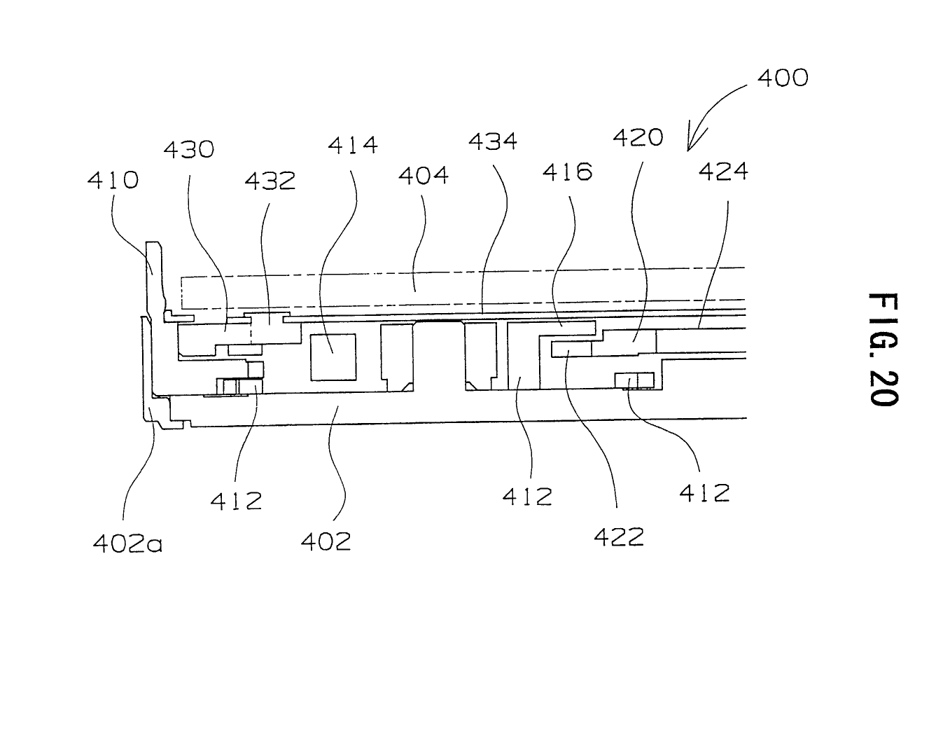

### DETAILED DESCRIPTION OF THE PREFERRED EMBODIMENTS

Hereunder, an embodiment of a timepiece with calendar mechanism of the present invention will be explained based on the drawings.

Although the explanation below is on a structure in which the timepiece with calendar mechanism of the invention is applied to an analog electronic timepiece, the invention is to be applied also to a mechanical timepiece besides the analog electronic timepiece. That is, the concept of “timepiece with calendar mechanism” in the present specification is a concept including “analog electronic timepieces”, “mechanical timepieces” and analog timepieces on all other operation principles.

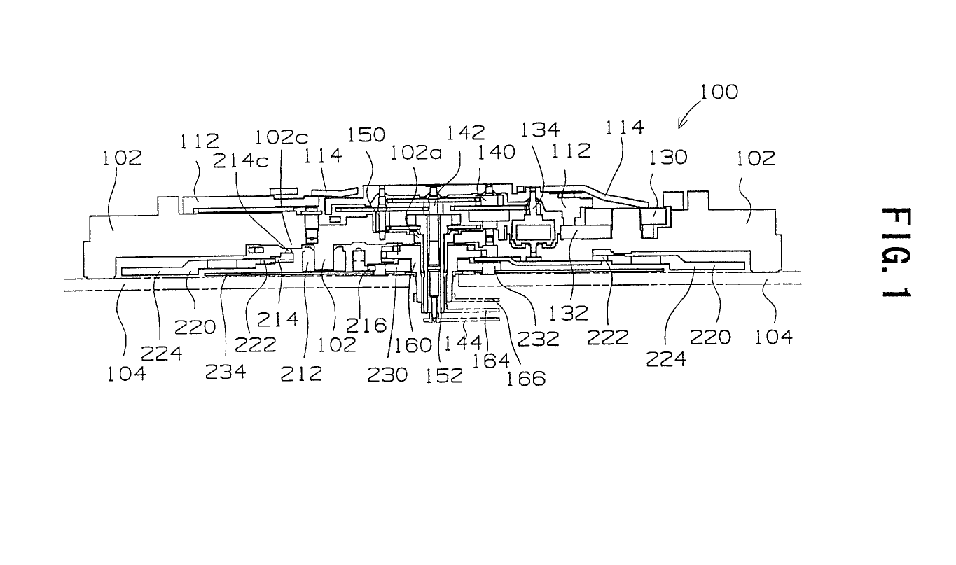

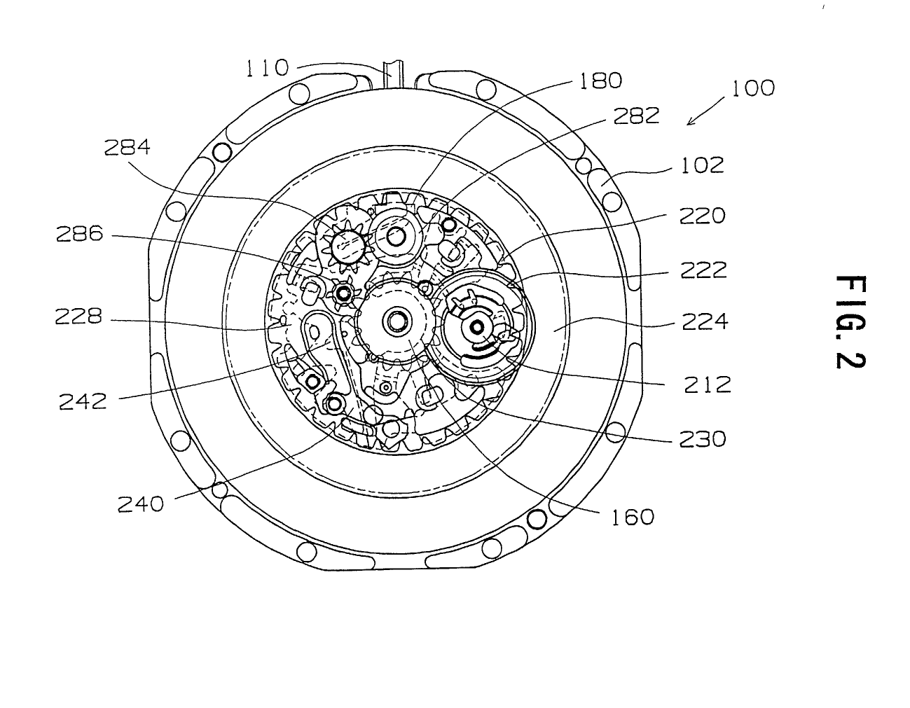

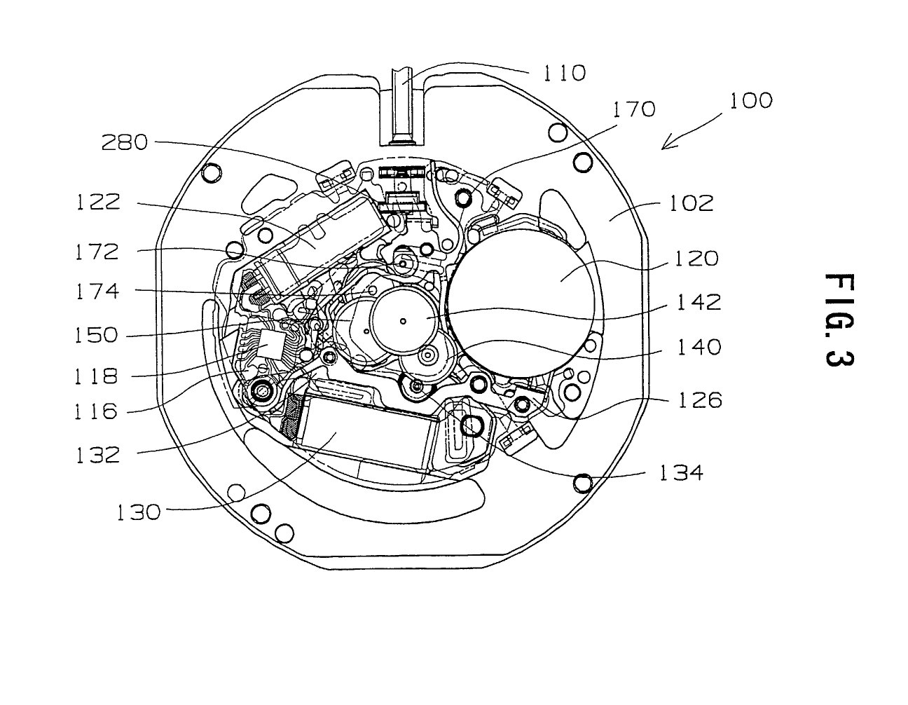

Referring to FIG. 1 to FIG. 4, a movement (mechanical body) 100 of the timepiece with calendar mechanism of the invention has a main plate 102 structuring a base plate for the movement 100. A dial 104 (shown by the virtual line in FIG. 1) is mounted on the movement 100.

On a “front side” of the movement 100 are arranged a battery 120, a circuit block 116, a step motor, a front train wheel, a change-over device (not shown) and so on. The front train wheel rotates due to rotation of the step motor. An IC 118 and a quartz oscillator 122 are attached on the circuit block 116. The battery 120 constitutes a power source for the timepiece with calendar mechanism. The quartz oscillator 122 constitutes source oscillation for the timepiece with calendar mechanism and oscillates, for example, at 372 or 768 Hertz.

The front train wheel is rotatably supported by the main plate 102 and train wheel bridge 112. A circuit holding plate 114 is provided in a manner holding the circuit block 116 to the train wheel bridge 112. A battery minus terminal 126 is held to the train wheel bridge 112. An insulation plate 128 is arranged between the battery minus terminal 126 and the holding plate 114.

The IC 118 includes an oscillator section, a frequency-divider section and a driver section. The oscillator section outputs a reference signal based on oscillation by the quartz oscillator 122. The frequency-divider section divides an output signal of the oscillator section. The driver section outputs a motor drive signal to drive the step motor based on the output signal of the frequency-divider section.

The step motor includes a coil block 130, a stator 132 and a rotor 134. When the coil block 130 inputs a motor drive signal, the stator 132 is magnetized to rotate the rotor 134. The rotor 134 is structured, for example, to rotate 180 degrees per second.

Based on rotation of the rotor 134, a fourth wheel and pinion 142 is structurally rotates through rotation of the fifth wheel and pinion 140. The fourth wheel and pinion 142 is structured to rotate once per minute. A second hand 144 is attached on the fourth wheel and pinion 142. The fourth wheel and pinion 142 may be arranged at a center of the timepiece or in a position other than the timepiece center.

A train wheel setting lever 170 is provided to be allowed to rotationally operated when drawing out a hand setting stem 110 to a second stage and regulates the position of the fourth wheel and pinion 142.

A third wheel and pinion 150 is structured to rotate based on rotation of the fourth wheel and pinion 142. A second wheel and pinion 152 is structured to rotate based on rotation of the third wheel and pinion 150. A minute wheel may be used in place of the center wheel and pinion 152. A minute hand 164 is attached on the second wheel and pinion 152. A slip mechanism is provided on the center wheel and pinion 152. When adjusting the hands by the slip mechanism, the minute hand 154 and an hour hand 156 can be rotated by rotating the hand setting stem 110 while the second hand 144 is stopped. The second wheel and pinion 152 is structured to rotate once per hour.

A minute wheel 174 is structured to rotate based on rotation of the second wheel and pinion 152. A setting wheel 172 is provided which rotates through rotation of a clutch wheel (not shown) when the hand setting stem 110 is drawn to the second stage. When the hand setting stem 110 is drawn to the second stage, structure is made to rotate through rotation of the minute wheel 174 and clutch wheel (not shown).

A center pipe 102a is provided on the main plate 102. An hour wheel 160 is rotatably provided on the center pipe 102a. The hour wheel 160 is structured to rotate once per 12 hours. An hour hand 166 is attached on the hour wheel 160.

By rotating a date indicator driving pinion (not shown) of the hour wheel 160, a date indicator driving wheel 212 is structurally rotate. The date indicator driving wheel 212 is provided to rotate once per day due to rotation of the hour wheel 160.

A date indicator 220 is provided rotatable relative to the main plate 102 in order to indicate date. The date indicator 220 has a date indicator teeth portion 222 having 31 teeth and a date plate 224 printed with characters to indicate date. A date indicator holder 228 rotatably holds the date indicator 220 relative to the main plate 102.

A day indicator 230 is rotatably provided relative to the main plate 102 in order to indicate day of the week. The day indicator 230 has a day star wheel 232 having 14 teeth and a day plate 234 printed with characters to indicate day of the week.

The rotation of the day indicator 220 is regulated by a date jumper 240. The rotation of the day indicator 230 is regulated by a day jumper 242. The day jumper 242 is integrally formed with the date indicator holder 228.

A first calendar correction wheel 280 is provided to rotate through rotation of the clutch wheel (not shown) when the hand setting stem 110 is with drawn to a first stage. A second calendar correction wheel 282 is provided to rotate through rotation of the clutch wheel and first calendar correction wheel 280 when the hand setting stem 110 is withdrawn to the first stage. A calendar correction wheel 284 is provided to rotate through rotation of the clutch wheel, first calendar correction wheel 280 and second calendar correction wheel 282 when the hand setting stem 110 is withdrawn to the first stage. The calendar correction wheel 284 is structured to swing only a constant angle about a rotation center of the second calendar correction wheel 282. A day correction transmission wheel 286 is arranged to rotate the day star wheel 232 by the rotation thereof.

When the hand setting stem 110 is withdrawn to the first stage, if the hand setting stem 110 is rotated in a first direction, the calendar correction wheel 284 structurally swings in the first direction and rotates at a constant position to enable the date indicator 220 to rotate. When the hand setting stem 110 is withdrawn to the first stage, if the hand setting stem 110 is rotated in a second direction (direction opposite to the first direction), the calendar correction wheel 284 is structurally swings in the second direction (direction opposite to the first direction) and rotates at a constant position to enable the day correction transmitting wheel 286 to rotate. By rotating the day correction transmitting wheel 286, the day star wheel 232 can be structurally rotated.

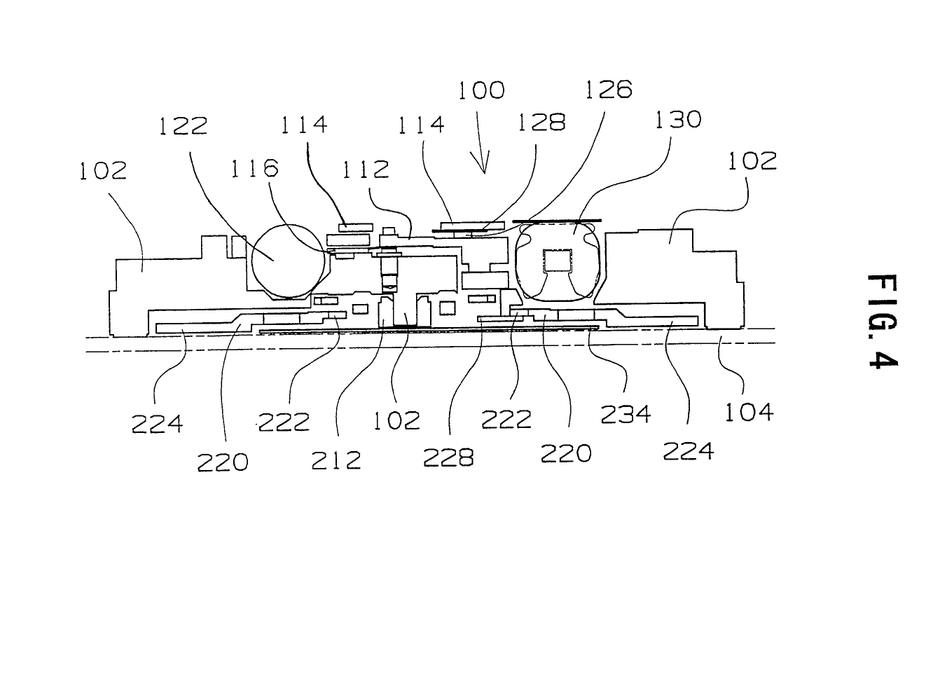

Referring to FIG. 4, a part of a quartz oscillator 122 and a part of the coil block 130 arranged on the “front side” are arranged in a manner overlapping the date indicator 220 arranged on a “back side” of the movement 100.

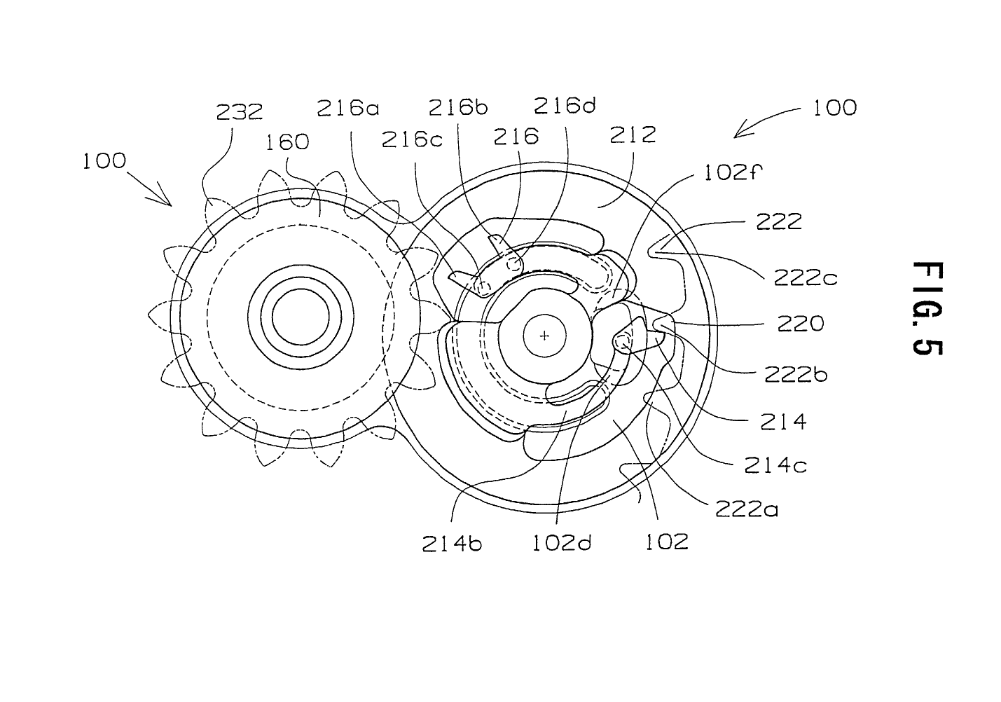

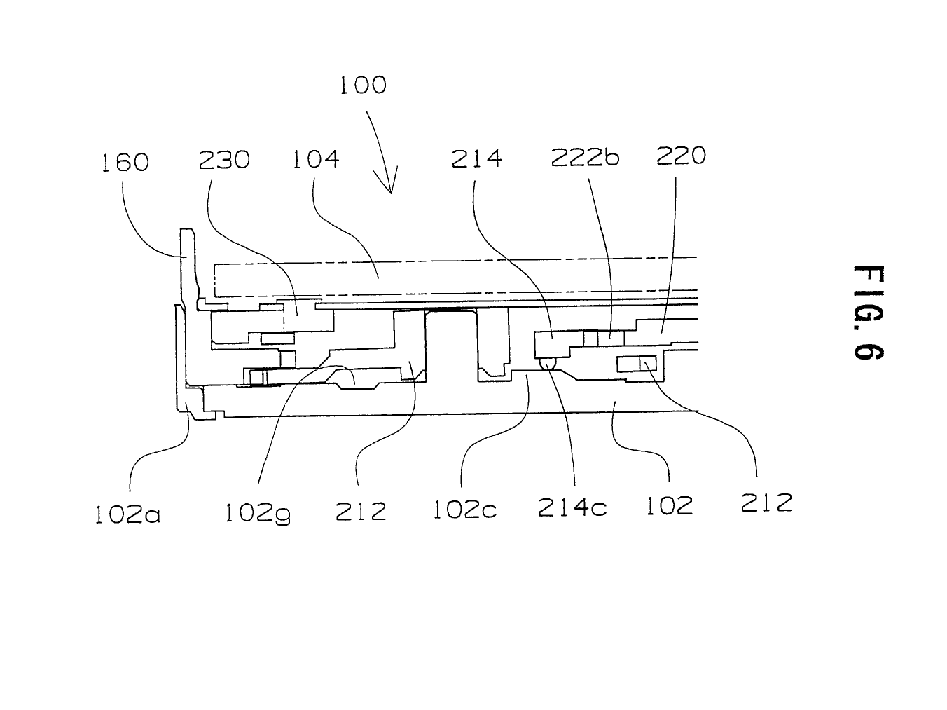

Referring to FIG. 5 and FIG. 6, date indicator teeth 222 includes a feed operation tooth portion 222b now to be fed, a feed-waiting tooth portion 222a next to be fed, and a fed tooth portion 222c having already fed. A date indicator driving wheel 212 has a date feed finger 214 capable of rotating the date indicator by an amount of one day per day and a day feed finger 216 capable of rotating the day indicator 230 by an amount of one day per day.

The date feed finger 214 is structured to be integral with the date indicator driving wheel 212 through a date feed finger spring portion 214b. The day feed finger 216 is structured to be integral with the date indicator driving wheel 212 through the day feed finger spring portion 216b.

A semispherical date feed finger convex portion is provided on the back side (main plate side) of the intersection of the date feed finger 214 and the date feed finger spring portion 214b.

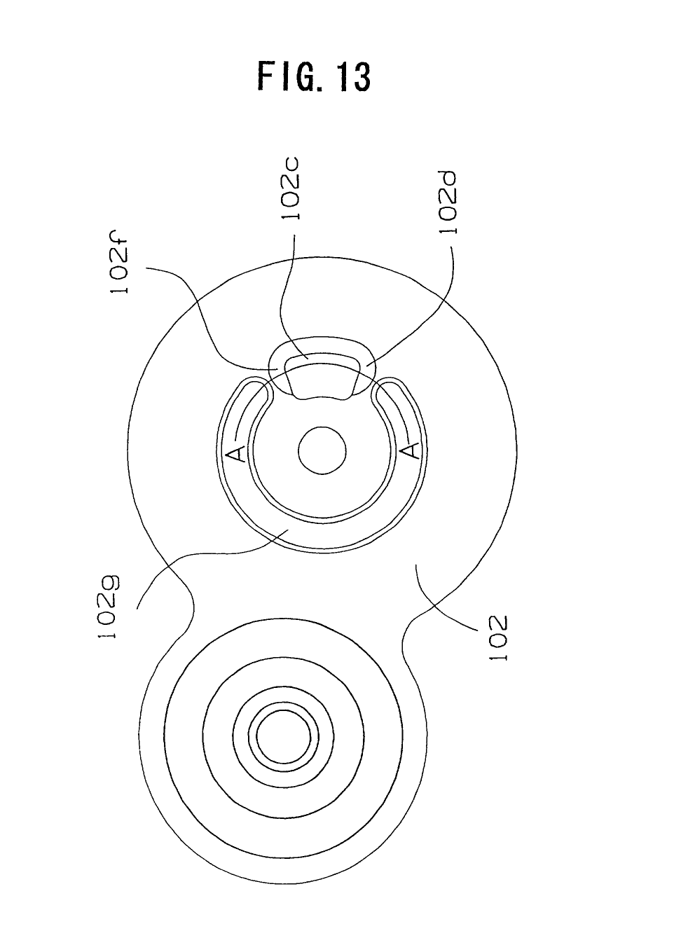

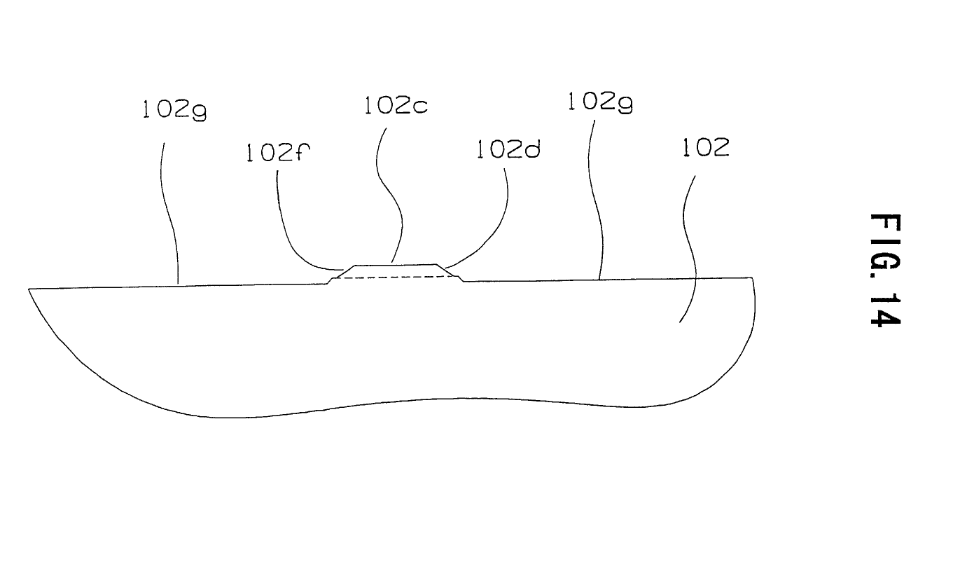

Referring to FIG. 13 and FIG. 14, a date feed finger guide portion 102c is provided on a back side (on a dial side) of the main plate 102, to secure an amount of meshing in a thickness direction between the date feed finger 214 and the feed operating tooth portion 222b when the date feed finger 214 meshes with the feed operating tooth portion 222b. A slant surface 102d is provided in an area that the date feed finger convex 214c first contacts the date feed finger guide portion 102c due to rotation of the date indicator 212. A slant surface 102f is provided in an area that the date feed finger convex 214c leaves the date feed finger guide portion 102c. In an area where the date feed finger guide portion 102c is not present, a date feed finger escape groove 102g is provided on the back side (on the dial side) of the main plate 102. The date feed finger convex 214c is structured to rotate facing the date feed finger escape groove portion 102g without contacting the date feed finger escape groove portion 102g.

Where teeth count of the day star wheel 232 is fourteen, the day feed finger 216 is structured to feed the day star wheel 232 by two teeth per day. A first day feed portion 216a and a second day feed portion 216b are structured to respectively feed teeth portions of the day star wheel 232 by one tooth in one time.

The day feed finger 216 and the first day feed portion 216a have an intersection portion on the back side of which is provided a semispherical first day feed finger convex portion 216c. The day feed finger 216 and the second day feed portion 216b have an intersection portion on the back side of which (on the main plate side) is provided a semispherical second day feed finger convex portion 216d.

Although the teeth count in the teeth portion of the day star wheel 232 was explained as fourteen in the embodiment of the invention shown in FIG. 5 and FIG. 6, the teeth count of the day star wheel 232 may be seven or may be twenty-one. Where the teeth count of the day star wheel 232 is seven, the day feed finger 216 is structured to feed the day star wheel 232 by one tooth per day. Where the teeth count of the day star wheel 232 is twenty-one, the day feed finger 216 is structured to feed the day star wheel 232 by three teeth per day.

Meanwhile, the first day feed portion 216a and second day feed portion 216b provided on the tip of the day feed finger 216 were explained as the respective structures to feed the teeth portion of the day star wheel 232 by one tooth per time. However, the structure may be made such that the one day feed portion provided at the tip of the day feed finger 216 feeds the teeth portion of the day star wheel 232 by two teeth.

Referring to FIG. 5 and FIG. 6, in the embodiment of the timepiece with calendar mechanism of the invention, the date feed finger convex portion 214c of the day feed finger 214 in a date feed state first contacts a slant surface 102d. By providing the slant surface 102d, the date feed finger 214 smoothly operates to move over the date feed finger guide portion 102c. Next, the date feed finger convex portion 214c of the date feed finger 214 operates over the date feed finger guide portion 102c of the main plate 102. By operation of the date feed finger convex portion 214c over the date feed finger guide portion 102c, it is possible to secure meshing in a thickness direction between the date feed finger 214 and the date indicator tooth portion when the date feed finger 214 meshes with the feed operation tooth portion 222b of the date indicator 220.

The date feed finger convex portion 214c of the date feed finger 214 operates contacting the slant surface 102f thus leaving from the date feed guide portion 102c. By this structure, it is possible to positively feed the date indicator 220 while smoothly rotating the date feed finger 214.

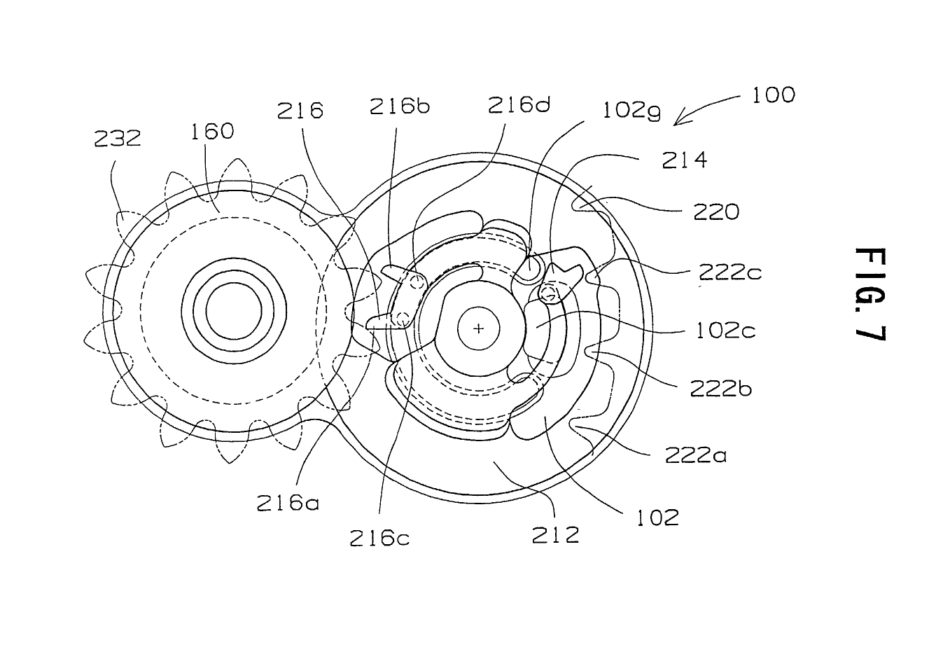

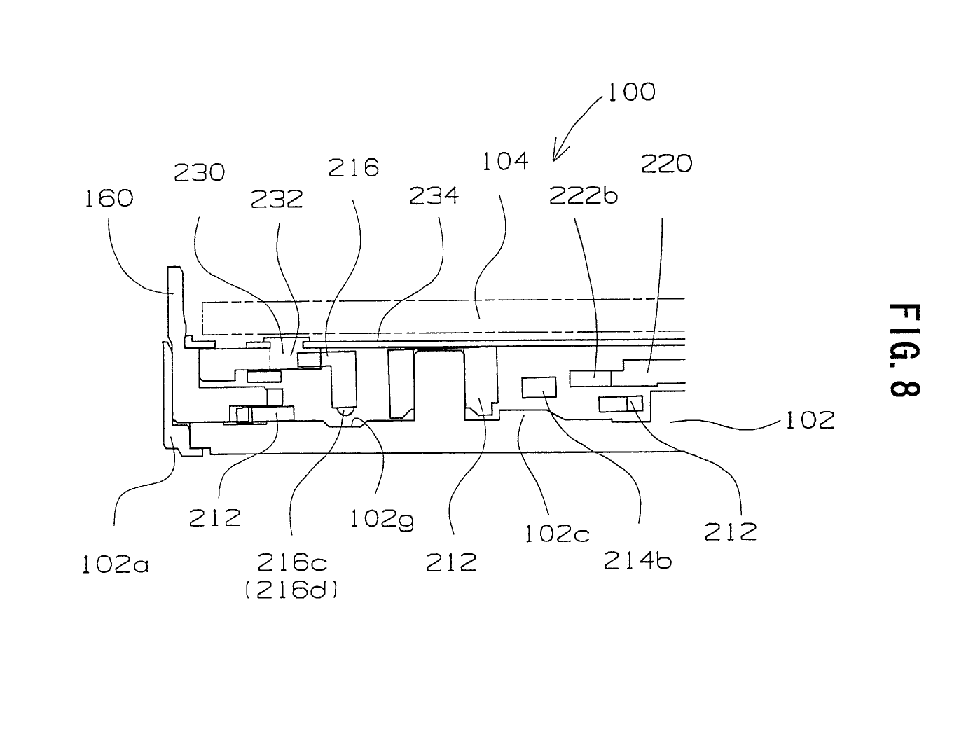

Referring to FIG. 7 and FIG. 8, in the embodiment of the timepiece with calendar mechanism of the invention, in a day feed state the first day feed portion 216a and the second feed portion 216b provided at the tip of the day feed finger 216 respectively feed one tooth of the teeth portion of the day star wheel 232 in one time. In the day feed state, the first day feed finger convex portion 216c and second day feed finger convex portion 216d face the date feed finger escape groove portion 102g and rotate without contact with the date feed finger escape groove portion 102g. Consequently, by this structure, the first day feed portion 216a operates without contacting the main plate 102 and also the second day feed portion 216b operates without contacting the main plate 102.

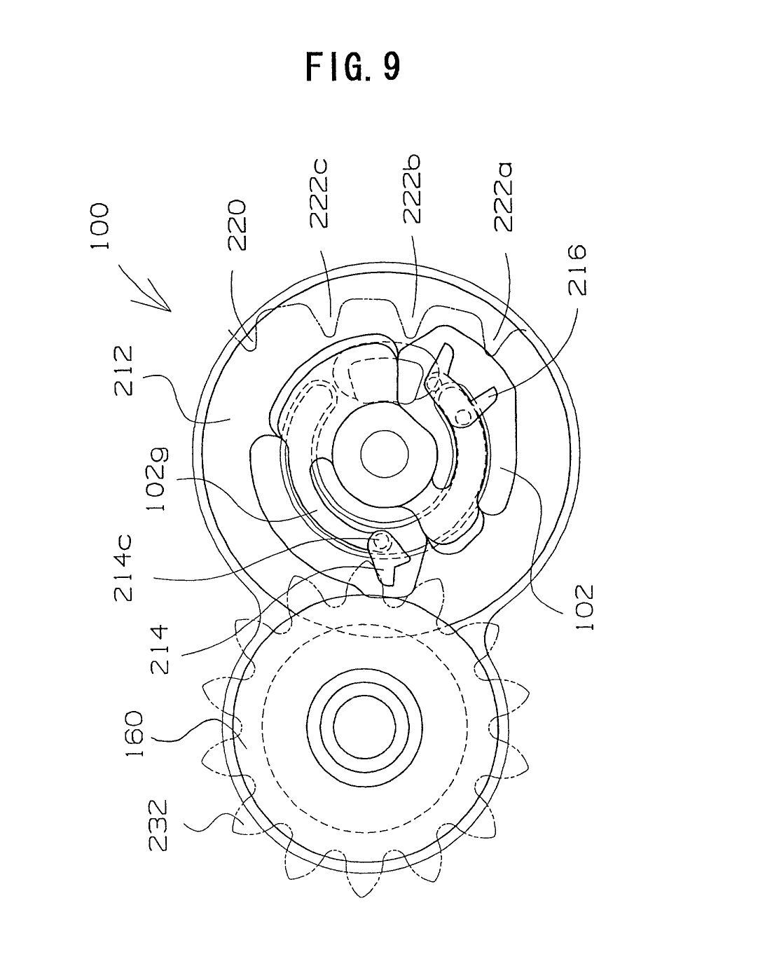

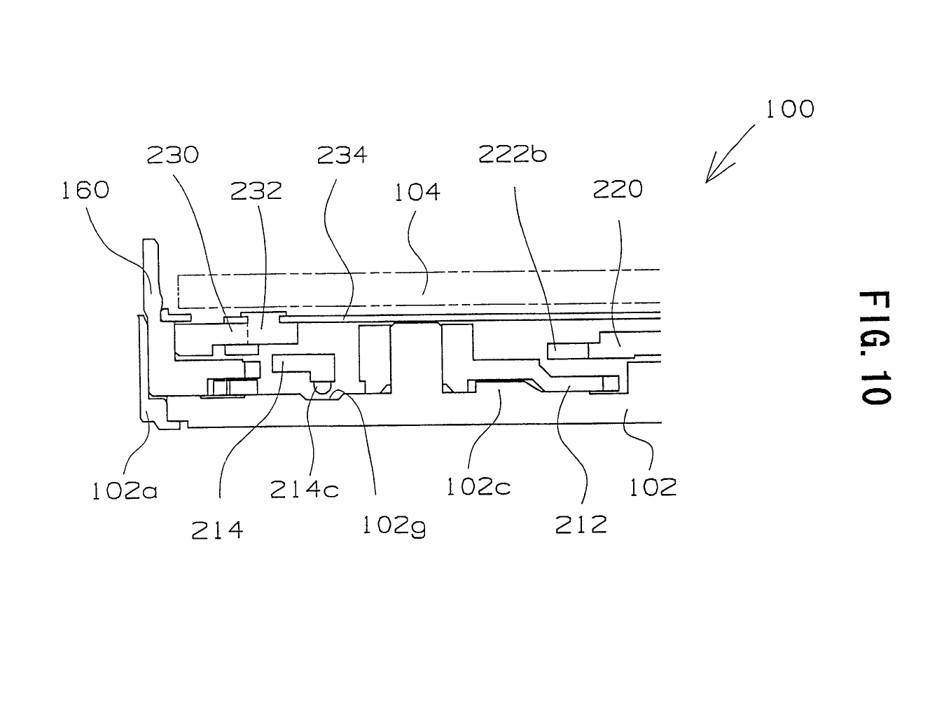

Referring to FIG. 9 and FIG. 10, in the embodiment of the timepiece with calendar mechanism of the invention, in a state that the date feed finger 214 positions beneath the day star wheel 232, the date feed finger 214 rotates between the day star wheel 232 and the main plate 102. That is, the date feed finger 214 rotates passing through the main plate 102 side of the day star wheel 232 of a day indicator 230. In this state, the date feed finger convex portion 214c is facing the date feed finger escape groove portion 102g and rotates without contacting the date feed finger escape groove portion 102g. Consequently, due to this structure, the date feed finger convex portion 214c of the date feed finger 214 operates without contacting the main plate 102.

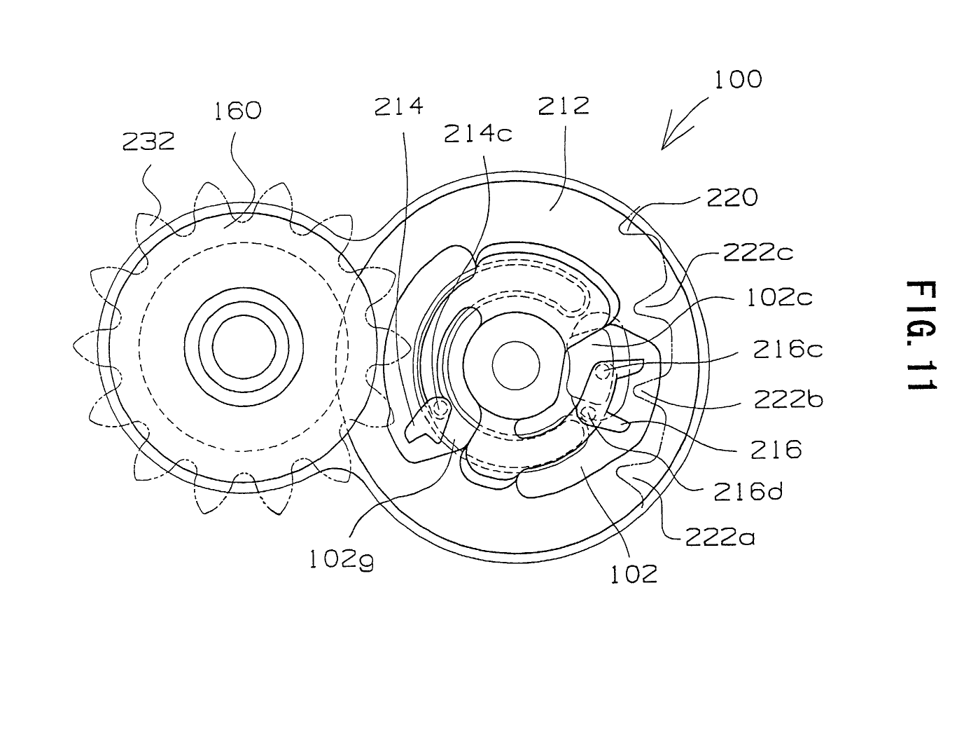

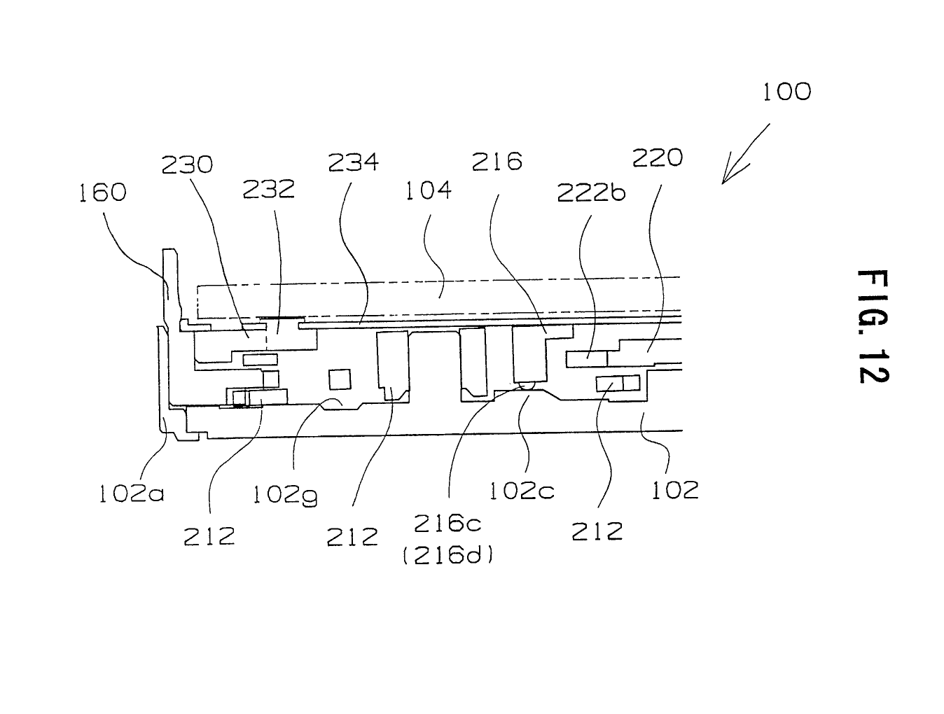

Referring to FIG. 11 and FIG. 12, in a state that the day feed finger 216 is close to the feed operating tooth portion 222b of the date indicator 220, the first day feed finger convex portion 216c and second day feed finger convex portion 216d of the day feed finger 216 operate riding on the date feed finger guide portion 102c of the main plate 102. That is, the first day feed finger convex portion 216c and second day feed finger convex portion 216d firstly contact the slant surface 102d. Next, the first day feed finger convex portion 216c and second day feed finger convex portion 216d operate over the date feed finger guide portion 102c of the main plate 102. Then, the first day feed finger convex portion 216c and second day feed finger convex portion 216d operate contacting the slant surface 102f, leaving from the date feed finger guide portion 102c. That is, the tip of the first day feed portion 216a and the tip of the second day feed portion 216b rotate between the date indicator 220 and the day plate 314. Due to this structure, the day feed finger 216 can be avoided from contacting the date indicator 220 while smoothly rotating the day feed finger 216.

Next, explanation will be made on another embodiment of a timepiece with calendar mechanism of the invention.

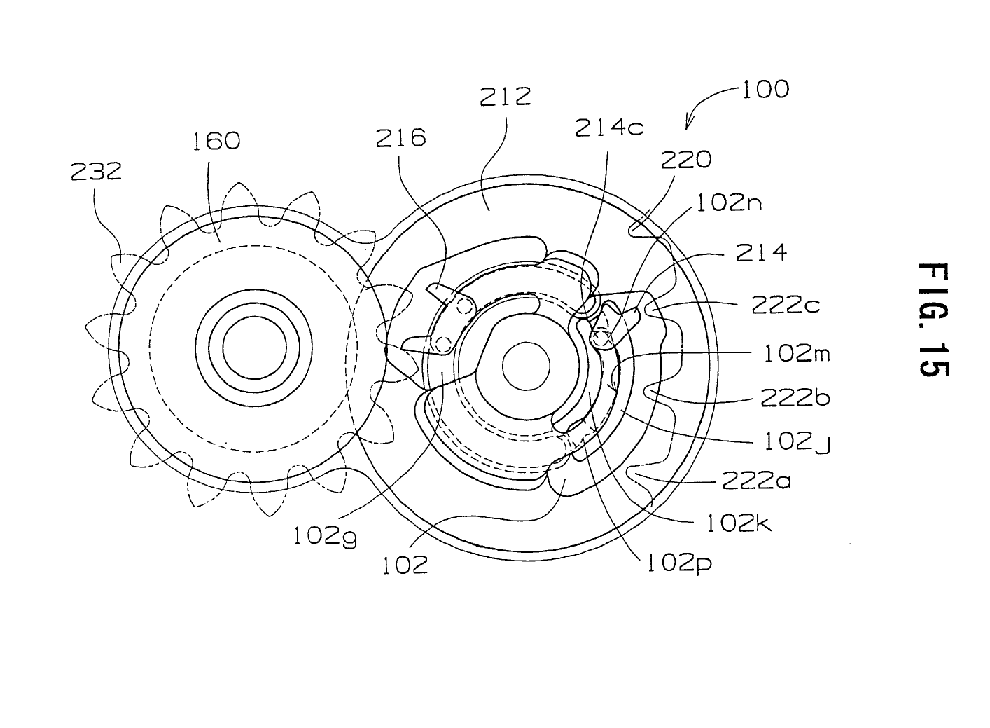

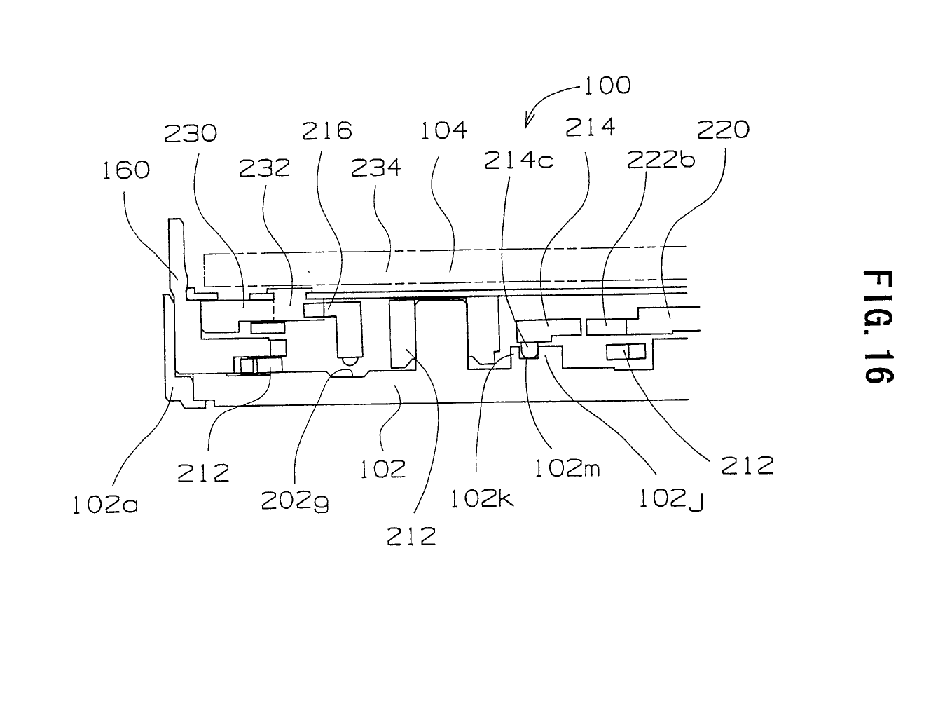

Referring to FIG. 15 and FIG. 16, in another embodiment of a timepiece with calendar mechanism of the invention, a date feed finger guide groove portion 102m is provided on the back side (on the dial side) of the main plate 102 to secure a meshing amount in a thickness direction between the date feed finger 214 and the feed operating tooth portion 222b when the date feed finger 214 meshes with the feed operating tooth portion 222b.

An inner guide portion 102k is provided on the back side (on the dial side) of the main plate 102 to prevent against decrease in meshing amount between the date feed finger 214 and the feed operating tooth portion 222b when the date feed finger meshes with the feed operating tooth portion 222b. An outer guide portion 102j is provided on the back side (on the dial side) of the main plate 102 to prevent against increase in meshing amount between the date feed finger 214 and the feed operating tooth portion 222b when the date feed finger meshes with the feed operating tooth portion 222b. Consequently, the date feed finger guide groove portion 102m positions between the outer guide portion 102j and the inner guide portion 102k. The date feed finger convex portion 214c operates in the date feed finger guide groove portion 102m between the outer guide portion 102j and the inner guide portion 102k.

By providing the inner guide portion 102k, it is possible to effectively prevent the mesh amount between the date feed finger 214 and the feed operating tooth portion 222b from decreasing more than required. That is, the inner guide portion 102k can prevent the date feed finger 214 from disengages from the feed operating tooth portion 222b during date feeding.

Also, by providing the outer guide portion 102j, it is possible to effectively prevent the mesh amount between the date feed finger 214 and the feed operating tooth portion 222b from increasing more than required. That is, the outer guide portion 102j can prevent the date feed finger 214 from caving in the feed operating tooth portion 222b during date feeding.

Accordingly, by this structure, the date feed finger 214 can positively rotate the date indicator 220.

Furthermore, it is preferred to provide a slant surface in a location that the date indicator driving wheel 212 rotates and the date feed finger convex portion 214c first contacts the date feed finger guide groove portion 102m. Also, it is also preferred to provide a slant surface in a location that the date feed finger convex portion 214c leaves from the date feed finger guide groove portion 102m. Also, in a position that the date feed finger guide groove portion 102m is absent, the date feed finger escape groove portion 102g is provided on the back side (on the dial side) of the main plate 102. That is, the date feed finger convex portion 214c is structured to rotate in the date feed finger guide groove portion 102m.

In addition, a date feed forward gap secure portion 102p is provided on the back side (on the dial side) of the main plate 102 to secure a clearance in a planar direction between the date feed finger 214 and the feed-waiting teeth portion 222a when the date feed finger 214 rotates near the feed-waiting teeth portion 222a. The date feed forward gap secure portion 102p is formed in a convex shape from the outer guide portion 102j toward the inner side and in a form of providing the entire with smoothness in order to keep the date feed finger 214 away from the feed-waiting teeth portion 222a. By this structure, there is no fear that the date feed finger 214 contacts the feed-waiting tooth portion 222a.

In addition, a date feed rear gap secure portion 102n is provided on the back side (on the dial side) of the main plate 102 to secure a clearance in the planar direction between the date feed finger 214 and the feed-waiting teeth portion 222a when the date feed finger 214 rotates near the feed-end teeth portion 222c. The date feed rear gap secure portion 102n is formed in a convex shape from the outer guide portion 102j toward the inner side and in a form of providing the entire with smoothness in order to keep the date feed finger 214 away from the feed-end teeth portion 222c. By this structure, there is no fear that the date feed finger 214 contacts the feed-end tooth portion 222c.

In a date feed state, the date feed finger portion 214c of the date feed finger 214 first contacts the slant surface. Next, the date feed finger convex portion 214c of the date feed finger 214 rotates in the date feed finger guide groove portion 102m of the main plate 102. By the operation of the date feed finger convex portion 214c in the date feed finger guide groove portion 102m, when the date feed finger meshes with the feed operating teeth portion 222b of the date indicator 220, it is possible to secure a meshing amount in a thickness direction between the date feed finger 214 and the feed operating teeth portion 222b. At the same time, it is possible to keep within a constant range the meshing amount in the planar direction between the date feed finger 214 and the date indicator teeth portion.

Next, the date feed finger convex portion 214c of the date feed finger 214 rotates contacting the date feed finger clearance securing portion 102n of the main plate 102. Then, the date feed finger convex portion 214c of the date feed finger 214 operates contacting the slant surface, leaving from the date feed finger guide groove portion 102m.

Next, explanation will be made on still another embodiment of a timepiece with calendar mechanism of the invention.

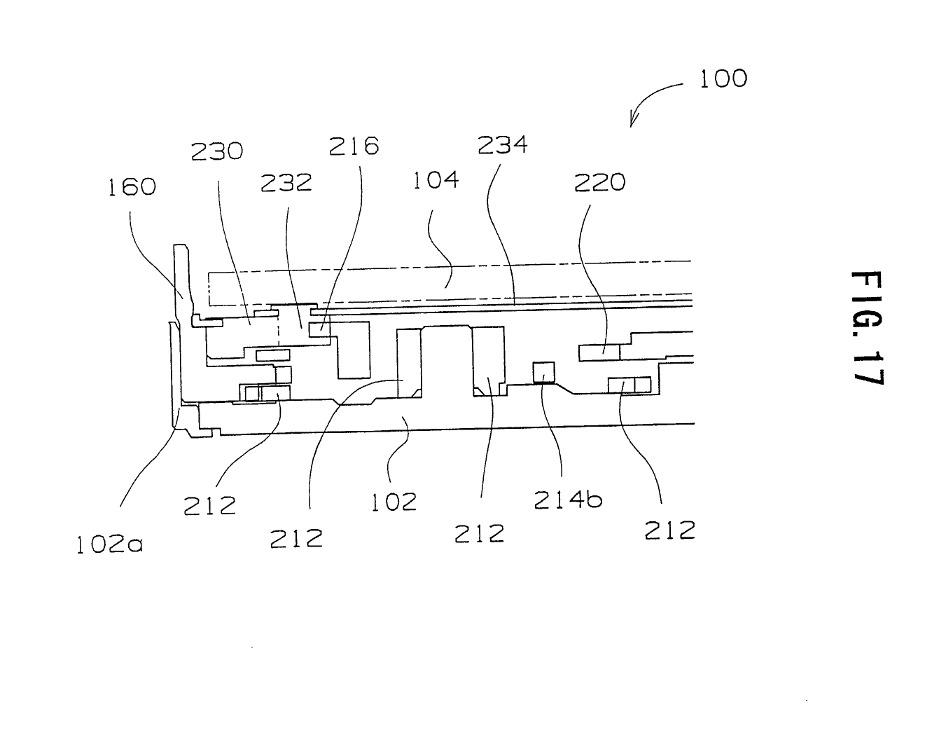

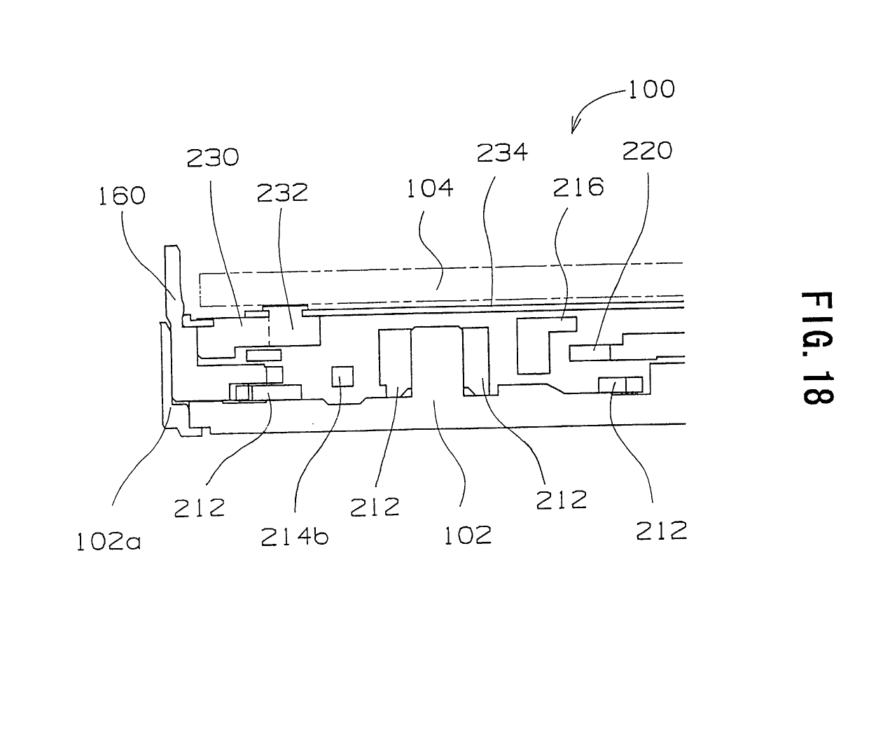

Referring to FIG. 17 and FIG. 18, in still another embodiment of a timepiece with calendar mechanism of the invention, the semispherical first day feed finger convex portion 216c is absent in the backside (on the main plate side) of the intersection between the day feed finger 216 and the first day feed portion 216a.

In this embodiment, by providing great a gap between the date indicator teeth portion 222 of the date indicator 220 and the day plate 234, the tip of the first day feed portion 216a and the tip of the second day feed portion 216b are structured to rotate between the date indicator 220 and the day plate 234.

Although the embodiments explained above explained the timepiece with a second hand, the structure of the invention is applicable to a timepiece without having a second hand.

The present invention, by being structured as explained above, can realize a timepiece with calendar mechanism free from fear of erroneous operation in the day indicator and has a date feed finger capable of positively rotating the date indicator.

Furthermore, the present invention can realize a timepiece with calendar mechanism small in size and thickness.

What is claimed is:

1. A timepiece with calendar comprising:
a date feed finger being structured integral with a date indicator driving wheel through a date feed finger spring portion and to rotate passing on main plate side of a day star wheel of a day indicator;
a day feed finger being structured integral with the date indicator driving wheel through a day feed finger spring portion;
the date indicator driving wheel having the date feed finger capable of rotating a date indicator by an amount of one day per day and the day feed finger capable of rotating a day indicator by an amount of one day per day;
a date feed finger guide portion to secure meshing in a thickness direction between the date feed finger and a date indicator teeth portion when the date feed finger meshes with the date indicator teeth portion.

2. A timepiece with calendar as claimed in claim 1, wherein a slant surface is provided in a portion that the date indicator driving wheel rotates and the date feed finger first contacts the date feed finger guide portion.

3. A timepiece with calendar as claimed in claim 1, wherein a semispherical convex portion is provided in a portion that the date feed finger contacts the date feed finger guide portion.

4. A timepiece with calendar as claimed in claim 1, wherein the day feed finger is structured to pass through on a dial side of the date indicator teeth portion, and
the day feed finger being structured to rotate contacting the date feed finger guide portion in order to secure a gap in a thickness direction between the day feed finger and the date indicator teeth portion when the day feed finger rotates through the dial side of the date indicator teeth portion.

5. A timepiece with calendar as claimed in claim 1, further comprising:
a date feed finger guide groove portion to secure a mesh amount in a thickness direction between the date feed finger and a feed operating tooth portion when the date feed finger meshes with the feed operating tooth portion to be fed in place of providing the date feed guide portion;
an inner guide portion to prevent a decrease of the mesh amount between the date feed finger and the feed operating tooth portion; and
an outer guide portion to prevent an increase of the mesh amount between the date feed finger and the feed operating tooth portion.

6. A timepiece with calendar as claimed in claim 5, further comprising:
a date feed forward gap secure portion to secure a gap in a planar direction between the date feed finger and a feed waiting tooth portion when the date feed finger rotates through a point near the feed waiting tooth portion to be next fed.

7. A timepiece with calendar as claimed in claim 5, further comprising:
a date feed rear gap secure portion to secure a gap in a planar direction between the date feed finger and a feed end tooth portion when the date feed finger) rotates through a point near the feed end tooth portion having been fed.

8. A timepiece with calendar as claimed in claim 6, further comprising:
a date feed rear gap secure portion to secure a gap in a planar direction between the date feed finger and a feed end tooth portion when the date feed finger) rotates through a point near the feed end tooth portion having been fed.

9. A timepiece with calendar as claimed in claim 1, wherein the timepiece with calendar is structured as an analog electronic timepiece, the timepiece with calendar having a quartz oscillator structuring source oscillation and a step motor to rotate the front train wheel, the step motor being structured to include a coil block, a stator and a rotor, and one part of the quartz oscillator and one part of the coil block being arranged to overlap with the date indicator.
